(19) United States
(12) Patent Application Publication
(10) Pub. No.: US 2026/0202271 A1
(43) Pub. Date: Jul. 16, 2026

(54) FORCE PLATE

(71) Applicant: SINTOKOGIO, LTD., Nagoya-shi (JP)

(72) Inventors: Ken NAGAI, Nagoya-shi (JP); Yoshikane TANAAMI, Nagoya-shi (JP); Makio SUZUKI, Nagoya-shi (JP); Takumi KOBAYASHI, Nagoya-shi (JP)

(73) Assignee: SINTOKOGIO, LTD., Nagoya-shi (JP)

(21) Appl. No.: 19/404,083

(22) Filed: Dec. 1, 2025

(30) Foreign Application Priority Data
Jan. 14, 2025 (JP) 2025-004866

(51) Int. Cl. G01L 1/20; G01L 1/22

(52) U.S. Cl. CPC G01L 1/205; G01L 1/22

(57) ABSTRACT

A force plate includes: a base plate; a top plate attached to the base plate; a strain element that is attached to the top plate, the strain element being configured to be deformed in accordance with deformation of the top plate; and a plurality of strain gauges configured to detect the deformation of the strain element.

This Nonprovisional application claims priority under 35 U.S.C. § 119 on Patent Application No. 2025-004866 filed in Japan on Jan. 14, 2025, the entire contents of which are hereby incorporated by reference.

### TECHNICAL FIELD

The present disclosure relates to a force plate.

### BACKGROUND ART

Typically, a force plate is a device that includes: a pair of an upper plate and a lower plate; and a load cell disposed between the upper plate and the lower plate, the load cell being configured to detect a force input into the plate. Note here that deformation of the upper plate may cause an error in detection; thus, as the upper plate, a thick metal plate is used (see Patent Literature 1).

Even in a case where such a plate is used, the upper plate is bent to some degrees, which can cause an error in detection. Patent Literature 1 discloses a technique that enables accurate detection of a force even if the upper plate is bent. This technique calculates, on the basis of a detection result from the load cell, forces Fx, Fy, and Fz in X-, Y-, and Z-directions and moments Mx and My around an X-axis and a Y-axis, and corrects the forces Fx, Fy, and Fz on the basis of the forces Fx, Fy, and Fz and the moments Mx and My.

### CITATION LIST

### Patent Literature

[Patent Literature 1]
Japanese Patent Application Publication, Tokukai, No. 2020-3275

### SUMMARY OF INVENTION

### Technical Problem

The inventors of the present invention conducted diligent study, and found the following fact. That is, according to the above-described conventional technique, the paired upper and lower plates are connected with each other via the load cell, and therefore a moment occurring between the plates and the moment causes an error in detection of a force applied to the plate.

An aspect of the present disclosure has an object to provide a force plate in which a moment between upper and lower plates connected with each other is reduced.

### Solution to Problem

In order to attain the above object, a force plate in accordance with an aspect of the present disclosure includes: a base plate; a top plate deformably attached to the base plate; a strain element attached to the top plate, the strain element being configured to be deformed in accordance with deformation of the top plate; and a plurality of strain gauges configured to detect deformation of the strain element.

### Advantageous Effects of Invention

In accordance with an aspect of the present disclosure, it is possible to provide a force plate in which a moment between upper and lower plates connected with each other is reduced.

### BRIEF DESCRIPTION OF DRAWINGS

FIG. 1 is a side cross-sectional view of a force plate in accordance with an embodiment of the present disclosure.

FIG. 2 is a top view of the force plate in accordance with the embodiment of the present disclosure.

### DESCRIPTION OF EMBODIMENTS

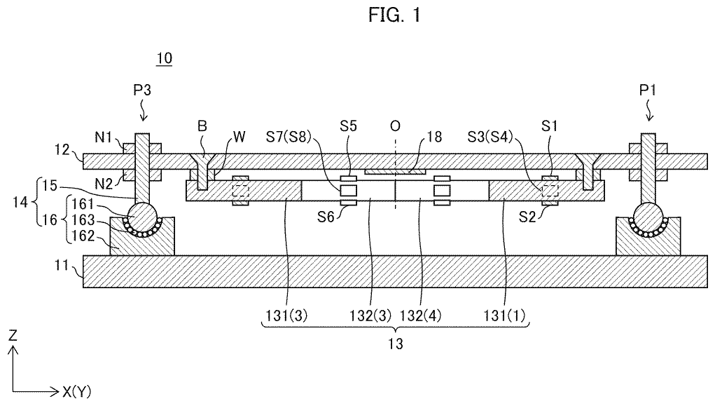

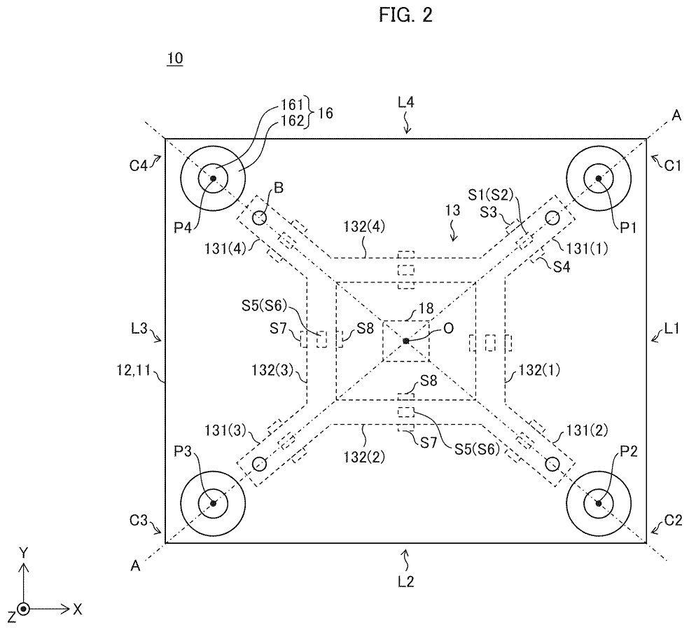

The following will describe details of an embodiment of the present disclosure. FIG. 1 is a side cross-sectional view of a force plate 10 in accordance with the embodiment of the present disclosure. FIG. 2 is a top view of the force plate 10 in accordance with the embodiment of the present disclosure. FIG. 1 illustrates the force plate 10 cut along a line A-A shown in FIG. 2. In each of FIGS. 1 and 2, an XYZ coordinate system having a Z-axis extending in a vertical direction and a center axis (center) O of the force plate 10 are illustrated.

The force plate 10 includes a base plate 11, a top plate 12, a strain element 13, and a plurality of strain gauges S. The base plate 11 corresponds to a lower part of the force plate 10, and is placed on, for example, a floor, a ground, or the like. The top plate 12 is attached to the base plate 11. The strain element 13 is attached to the top plate 12, and is deformed in accordance with deformation of the top plate 12. The strain gauges S detect the deformation of the strain element 13.

The top plate 12 is in the shape of a flat plate, and has a polygonal shape having a first corner C1 to an n-th corner Cn (n is an integer of not less than 3) in a plan view seen in a Z-axis positive direction. In a plan view, the top plate 12 has a first side L1, a second side L2, . . . , and an n-th side Ln, the first side L1 being arranged at a location between the first corner C1 and the second corner C2, the second side L2 being arranged a location between the second corner C2 and the third corner C3, . . . , and the n-th side Ln being arranged at a location between the n-th corner Cn and the first corner C1. In FIGS. 1 and 2, the top plate 12 has a substantially quadrangular shape, and has a first corner C1 to a fourth corner C4. Alternatively, the top plate 12 may have a substantially triangular shape or a substantially pentagonal shape. The subsequent description will be given assuming that the top plate 12 can have an n-polygonal shape in a plan view.

The top plate 12 may be made of metal such as stainless steel or a cold rolled steel (SPC; steel plate cold), and may have a size of 600*900 mm, for example. The top plate 12 is deformable, and may have, for example, a thickness of 10 to 20 mm and/or a Young's modulus of not more than 210 GPa (e.g., 150 to 210 GPa). That is, in the present disclosure, the top plate 12 is allowed to be deformed; therefore, the top plate 12 may not have high rigidity and can have a thickness that is reduced to some degrees. This can reduce the weight of the top plate 12, which in turn leads to reduction in the weight of the force plate 10.

The base plate 11 is in the shape of a flat plate, and may be identical in shape and size to the top plate 12. In FIGS. 1 and 2, similarly to the top plate 12, the base plate 11 has a substantially quadrangular shape in a plan view, and is identical in shape to the top plate 12. Alternatively, the base plate 11 may be different in shape and size from the top plate 12. For example, the top plate 12 may have a substantially triangular shape in a plan view, and the base plate 11 may have a substantially quadrangular shape. Further, the base plate 11 may be larger in size than the top plate 12.

The force plate 10 may include a plurality of connection members 14 that connect the base plate 11 and the top plate 12 with each other in such a manner as to allow the top plate 12 to be deformed with respect to the base plate 11. In FIGS. 1 and 2, the plurality of connection members 14 each include a spherical bearing 16. By connecting the base plate 11 and the top plate 12 with each other via the spherical bearings 16, it is possible to reduce a moment between the base plate 11 and the top plate 12.

To be more specific, as shown in FIG. 1, the plurality of connection members 14 respectively include: bar-shaped members 15 each of which is connected with one of the base plate 11 and the top plate 12; and the spherical bearings 16 each of which connects the other of the base plate 11 and the top plate 12 with a corresponding one of the bar-shaped members 15. Further, the spherical bearings 16 respectively include: outer rings 162 each of which is attached to the other of the base plate 11 and the top plate 12; and inner rings 161 each of which is attached to a corresponding one of the bar-shaped members 15. That is, the spherical bearings 16 may be disposed to either of the base plate 11 or the top plate 12.

In FIGS. 1 and 2, the spherical bearings 16 are disposed to the base plate 11. Thus, the spherical bearings 16 respectively include the outer rings 162 attached to the base plate 11, and the bar-shaped members 15 are connected with the top plate 12. The top plate 12 may have through-holes, through which the bar-shaped members 15 may be inserted. Each of the bar-shaped members 15 may have screw grooves, and may be connected or fixed to the top plate 12 by nuts N1 and N2 that are respectively disposed on upper and lower sides of the top plate 12. The bar-shaped members 15 may be connected with the top plate 12 by another means. For example, the bar-shaped members 15 may be connected with the top plate 12 by welding.

In FIGS. 1 and 2, the connection between the base plate 11 and the top plate 12 can be released by removing the nuts N1 and N2. This enables easy disassembly, easy carrying, and easy assembly of the force plate 10. As described above, the feature that the weight of the top plate 12 can be reduced contributes to the easy disassembly, easy carrying, and easy assembly.

In each of the spherical bearings 16, the inner ring 161 connected with the top plate 12 via its respective bar-shaped member 15 is rotatable with respect to the outer ring 162 connected with the base plate 11. Note that a small ball 163 may be disposed between the inner ring 161 and the outer ring 162 in order to enhance the rotatability therebetween. In this manner, the base plate 11 and the top plate 12 are connected with each other by the spherical bearings 16 in a rotatable manner. This reduces a moment between the base plate 11 and the top plate 12. Consequently, correspondence between a force acting on the top plate 12 and deformation of the top plate 12 is made clear. Thus, by detecting deformation of the strain element 13 that is configured to be deformed in accordance with the top plate 12, it is possible to more accurately detect the force acting on the top plate 12.

Meanwhile, in a case where the base plate 11 and the top plate 12 are connected with each other in such a manner as to prevent rotation therebetween (i.e., to restrict deformation of the top plate 12) (for example, the base plate 11 and the top plate 12 are connected with each other by a load cell, such as those indicated in Patent Literature 1), a moment between the base plate 11 and the top plate 12 occurs at the connection part. The top plate 12 is deformed not only by the force applied to the top plate 12 but also by this moment. In such a case, correspondence between the force acting on the top plate 12 and the deformation of the top plate 12 is unclear. That is, even when deformation of the top plate 12 is detected by using the strain element 13, it is difficult to accurately detect the force acting on the top plate 12. As discussed above, a moment occurring between the base plate 11 and the top plate 12 can cause an error in detection of the force applied to the top plate 12.

In order to deal with this, according to the present disclosure, the top plate 12 is attached to the base plate 11 in a deformable manner. This reduces a moment acting between the base plate 11 and the top plate 12, thereby making it easier to more accurately detect a force acting on the top plate 12.

As described above, in FIGS. 1 and 2, the spherical bearings 16 are disposed to the base plate 11. Meanwhile, the spherical bearings 16 may be disposed to the top plate 12. In this case, the plurality of connection members 14 respectively include: bar-shaped members 15 each of which is connected with the base plate 11; and spherical bearings 16 each of which connects the top plate 12 with a corresponding one of the bar-shaped members 15. Each spherical bearing 16 includes an outer ring 162 attached to the top plate 12 and an inner ring 161 attached to the bar-shaped member 15.

Furthermore, the spherical bearings 16 may be disposed to both the base plate 11 and the top plate 12. By disposing the spherical bearings 16 to both the base plate 11 and the top plate 12, it is possible to further reduce a moment between the base plate 11 and the top plate 12. In this case, for example, a first spherical bearing 16 may include an outer ring 162 attached to the base plate 11, a second spherical bearing 16 may include an outer ring 162 attached to the top plate 12, and an inner ring 161 of the first spherical bearing 16 and an inner ring 161 of the second spherical bearing 16 may be connected with each other via a bar-shaped member 15.

Note here that the plurality of connection members 14 are preferably arranged at the corners C1 to Cn of the top plate 12, respectively. That is, the plurality of connection members 14 may include the first to n-th connection members 14 respectively arranged at first to n-th connection positions P1 to Pn, which are closer to the first to n-th corners C1 to Cn than to a center (center O) of the top plate 12.

The strain element 13 has a beam-like shape, and can be divided into (i) periphery-side beam members 131 arranged closer to a periphery of the top plate 12 and (ii) center-side beam members 132 arranged closer to the center of the top plate 12. The strain element 13 may be in the shape of a flat plate.

The periphery-side beam members 131 include first to n-th periphery-side beam members 131(1) to 131(n) that are arranged radially. In one example, the number n of periphery-side beam members 131(i) is four. Increasing the number n of periphery-side beam members 131(i) makes it easier to more accurately detect a force applied to a part of the top plate 12 which part is closer to the periphery.

To be more specific, the first to n-th periphery-side beam members 131(1) to 131(n) extend from the center O of the top plate 12 toward the first to n-th connection positions P1 to Pn, respectively. In FIGS. 1 and 2, the strain element 13 is connected with the top plate 12 at parts near end parts of the first to n-th periphery-side beam members 131(1) to 131(n) which end parts are closer to the periphery. The configuration in which the strain element 13 is connected with the top plate 12 at the end parts closer to the periphery makes it easier to reflect deformation of the substantial entire top plate 12 to deformation of the strain element 13 and accordingly to accurately detect the force applied to the top plate 12.

The strain element 13 and the top plate 12 may be connected with each other at more parts in addition to the parts near the end parts of the periphery-side beam members 131 (strain element 13) which end parts are closer to the periphery. For example, the strain element 13 may be fixed to the top plate 12 at connection parts (boundaries) between the periphery-side beam members 131 and the center-side beam members 132. This makes it possible to clarify the respective roles of the periphery-side beam members 131 and the center-side beam members 132. That is, in this case, the periphery-side beam members 131 detect deformation of a part of the top plate 12 which part is closer to the periphery than to the connection parts (boundaries), and the center-side beam members 132 detect deformation of a part of the top plate 12 which part is closer to the center than to the connection parts (boundaries).

In FIGS. 1 and 2, the strain element 13 is connected with the top plate 12 via a screw B. In this connection, a ring-shaped washer W is disposed between the strain element 13 and the top plate 12. This configuration is given for the purpose of (i) reducing interference between the top plate 12 and the strain element 13 that may occur at other position(s) than the connection parts and (ii) making it easier to dispose the strain gauges on a surface (upper surface) of the strain element 13 which surface faces a main surface of the top plate 12.

The center-side beam members 132 include first to n-th center-side beam members 132(1) to 132(n). Note here that the number n of center-side beam members 132(i) is four, for example. Increasing the number n of center-side beam members 132(i) makes it easier to more accurately detect a force applied to a part of the top plate 12 which part is closer to the center.

The center-side beam members 132 may include the first to n-th center-side beam members 132(1) to 132(n) arranged closer to the center of the top plate 12 such that the first to n-th center-side beam members 132(1) to 132(n) respectively correspond to first to n-th sides L1 to Ln of the top plate 12. That is, an i-th center-side beam member 132(i) is arranged so as to correspond to an n-th side Li. This means that the i-th center-side beam member 132(i) corresponds to a direction of the i-th side Li. Each of the first to n-th center-side beam members 132(1) to 132(n) is connected with an adjacent center-side beam member 132(i) at a corresponding one of first to n-th connection parts respectively corresponding to the first to n-th corners C1 to Cn.

As discussed above, the i-th center-side beam member 132(i) corresponds to the i-th side Li. On the other hand, the i-th center-side beam member 132(i) may not correspond to the i-th side Li. That is, the center-side beam member 132(i) can be arranged so as not to correspond to a shape of the top plate 12.

In FIGS. 1 and 2, the center-side beam members 132 include four center-side beam members 132(1) to 132(4) respectively corresponding to the four sides L1 to L4 of the top plate 12. Each of the four center-side beam members 132(1) to 132(4) is connected with an adjacent center-side beam member 132(i) at a corresponding one of the four connection parts respectively corresponding to the four corners C1 to C4.

Each of the first to n-th periphery-side beam members 131(1) to 131(n) may be connected with at least one of the first to n-th center-side beam members 132(i) at a corresponding one(s) of the first to n-th connection parts. In FIGS. 1 and 2, the first periphery-side beam member 131(1) is connected with the fourth center-side beam member 132(4) and the first center-side beam member 132(1). The second periphery-side beam member 131(2) is connected with the first center-side beam member 132(1) and the second center-side beam member 132(2). The third periphery-side beam member 131(3) is connected with the second center-side beam member 132(2) and the third center-side beam member 132(3). The fourth periphery-side beam member 131(4) is connected with the third center-side beam member 132(3) and the fourth center-side beam member 132(4).

Each of the first to n-th periphery-side beam members 131(1) to 131(n) includes: a first surface (upper surface) that faces the main surface of the top plate 12; a second surface (lower surface) that is located opposite to the main surface of the top plate 12; and a third surface and a fourth surface that intersect the main surface of the top plate 12 (two side surfaces that face opposite directions). A plurality of strain gauges S1 to S4 include first to fourth strain gauges S1 to S4 respectively disposed on the first to fourth surfaces. The first to fourth strain gauges S1 to S4 make it easier to detect deformation of a part of the top plate which part is closer to the periphery of the top plate 12 both in a vertical direction and a horizontal direction with respect to the surface of the top plate 12.

Each of the first to n-th center-side beam members 132(1) to 132(n) includes: a fifth surface (upper surface) that faces the main surface of the top plate 12; a sixth surface (lower surface) that is located opposite to the main surface of the top plate 12; and a seventh surface and an eighth surface that intersect the main surface of the top plate 12 (two side surfaces that face opposite directions). A plurality of strain gauges S5 to S8 include fifth to eighth strain gauges S5 to S8 respectively disposed on fifth to eighth surfaces. The fifth to eighth strain gauges S5 to S8 make it easier to detect deformation of a part of the top plate which part is closer to the center of the top plate 12 both in the vertical direction and the horizontal direction with respect to the surface of the top plate 12.

In the above description, the strain element 13 is divided into the periphery-side beam members 131 and the center-side beam members 132. Alternatively, the strain element 13 may not be divided in such a manner. For example, the strain element 13 may be connected with the center O of the top plate 12 and may be constituted by a plurality of beam members 132 extending radially from the center O. Such a strain element 13 may be considered as not having any center-side beam member 132 and as being constituted by the periphery-side beam members 131.

The force plate 10 includes a detection section 18 that detects at least one of an acceleration, an angular velocity, and an inclination of the top plate 12. It is possible to detect at least one of an acceleration, an angular velocity, and an inclination of the entire top plate 12. As the detection section 18, for example, an accelerometer, an angular velocity meter, or a clinometer (posture angle sensor) may be used to detect the acceleration and/or the like. As the detection section 18, an inertial measurement unit (IMU) including at least one of the accelerometer, the angular velocity meter, and the clinometer may be used.

The acceleration, angular velocity, and inclination detected by the detection section 18 may be used for interpolation of detection of a force carried out by the strain element 13 and the strain gauges S. For example, by combining a value of the detected force with values of the detected acceleration and angular velocity, it is possible to improve efficiency and accuracy in a calculation process of a force. Similarly, by combining the value of the detected force with a value of the detected inclination, it is possible to improve efficiency and accuracy in the calculation process of the force.

The force plate 10 in accordance with the present disclosure includes: the base plate 11; the top plate 12 that is deformably attached to the base plate 11; the strain element 13 that is attached to the top plate 12 and that is configured to be deformed in accordance with deformation of the top plate 12; and the plurality of strain gauges S that are configured to detect the deformation of the strain element 13.

With this, the top plate 12 is deformably attached to the base plate 11. This reduces a moment between the top plate 12 and the base plate 11.

In comparison to conventional force plates (disclosed in Patent Literature 1, for example), the force plate 10 in accordance with the present disclosure has the following merits.
(1) It is possible to reduce the weight of the top plate 12, which in turn leads to reduction in the weight of the force plate 10. As described above, the top plate 12 does not need to have high rigidity. This makes it possible to reduce the thickness of the top plate 12, thereby reducing the weight.
(2) It is possible to provide easy disassembly, easy carrying, and easy assembly of the force plate 10. As described above, for example, by removing the nuts N1 and N2, it is possible to release the connection between the base plate 11 and the top plate 12. The configuration in which the weight of the top plate 12 can be reduced contributes to the easy disassembly, easy carrying, and easy assembly.
(3) It is possible to eliminate the need to incorporate a precision detection section, such as a force sensor, into the force plate 10. Attaching the strain element 13 including the strain gauges S1 to S4 to the top plate 12 makes it possible to detect a force applied to the top plate 12.

As a result of elimination of the need for the force sensor and/or the like, which is relatively expensive, it is possible to provide a less expensive force plate 10. Furthermore, since the precise force sensor and/or the like is not used, the top plate 12 does not require high-level processing accuracy, in comparison to that required for the configuration including the force sensor. This contributes to providing a less expensive force plate 10.
(4) It is possible to simplify the structure of the force plate 10. The force plate 10 has a simple structure constituted by the base plate 11, the top plate 12, and the strain element 13. This structure contributes to providing a less expensive force plate 10. Further, this structure involves relatively less machining processing, which contributes to providing a less expensive force plate 10.

Furthermore, simplifying the structure means making it easier to manufacture force plates 10 of various sizes ranging from a small size to a large size. As described above, the configuration in which the top plate 12 does not require high-level processing accuracy also contributes to making it easier to manufacture of force plates 10 of various sizes.
(5) If necessary, the detection section 18 such as an accelerometer can be additionally provided to the top plate 12 to detect an acceleration and/or the like of the top plate 12.

As discussed above, the force plate 10 in accordance with the present disclosure has various merits.

### (Variations)

The following will discuss a force plate 10 in accordance with a variation of the present disclosure. In the description of the above embodiment, each of the base plate 11 and the top plate 12 has a quadrangular shape in a plan view. Alternatively, a top plate 12 may have a polygonal shape having first to n-th corners C1 to Cn (n is an integer of not less than three). That is, the top plate 12 may have a triangular shape or a pentagonal shape.

For example, in a case where the top plate 12 has a triangular shape, a strain element 13 may have three center-side beam members 132(1) to 132(3) and three periphery-side beam members 131(1) to 131(3). The three center-side beam members 132(1) to 132(3) may be arranged in a triangular shape. From corners of this triangular shape, the three periphery-side beam members 131(1) to 131(3) may respectively extend toward three corners C1 to C3 of the top plate 12. Such force plates 10 including top plates 12 having various types of polygonal shapes are also encompassed in the scope of the present disclosure.

Aspects of the present invention can also be expressed as follows:
A force plate in accordance with a first aspect includes: a base plate; a top plate attached to the base plate; a strain element attached to the top plate, the strain element being configured to be deformed in accordance with deformation of the top plate; and a plurality of strain gauges configured to detect deformation of the strain element.

In accordance with the first aspect, the top plate is deformably attached to the base plate. This can reduce a moment between the base plate and the top plate. This makes it easier to more accurately detect, by the strain gauges, a force applied to the top plate.

A force plate in accordance with a second aspect may be configured such that, in the first aspect, the force plate further includes: a plurality of connection members that connect the base plate and the top plate with each other in such a manner as to allow the top plate to be deformed with respect to the base plate.

In accordance with the second aspect, a moment between the base plate and the top plate is further reduced by the plurality of connection members to which the top plate is deformably connected.

A force plate in accordance with a third aspect may be configured such that, in the second aspect, the plurality of connection members respectively include spherical bearings.

In accordance with the third aspect, a moment between the base plate and the top plate is reduced more surely by the spherical bearings.

A force plate in accordance with a fourth aspect may be configured such that, in the third aspect, the plurality of connection members respectively include (a) bar-shaped members each of which is connected with one of the base plate and the top plate and (b) the spherical bearings each of which connects the other of the base plate and the top plate with a corresponding one of the bar-shaped members; and each of the spherical bearings includes (a) an outer ring that is connected with the other of the base plate and the top plate and (b) an inner ring that is attached to a corresponding one of the bar-shaped members.

In accordance with the fourth aspect, a moment between the base plate and the top plate is reduced more surely by the spherical bearings disposed to the base plate or the top plate.

A force plate in accordance with a fifth aspect may be configured such that, in any one of the second to fourth aspects, the top plate has a polygonal shape having first to n-th corners in a plan view, where n is an integer of not less than three; and the plurality of connection members include first to n-th connection members that are respectively arranged at first to n-th connection positions, which are closer to the first to n-th corners than to a center of the top plate.

In accordance with the fifth aspect, the connection members are respectively arranged at the first to n-th connection positions, which are closer to the first to n-th corners than to the center of the top plate. Consequently, the entire top plate can be easily deformed by the applied force.

A force plate in accordance with a sixth aspect may be configured such that, in the fifth aspect, the strain element includes first to n-th periphery-side beam members that extend from the center of the top plate toward the first to n-th connection positions, respectively.

In accordance with the sixth aspect, the first to n-th periphery-side beam members, which extend from the center of the top plate toward the first to n-th connection positions, respectively, can be deformed in accordance with deformation of the top plate in directions of the first to n-th corners.

A force plate in accordance with a seventh aspect may be configured such that, in the sixth aspect, each of the first to n-th periphery-side beam members has a first surface that faces a main surface of the top plate, a second surface that is located opposite to the main surface of the top plate, and a third surface and a fourth surface that intersect the main surface of the top plate; and the plurality of strain gauges include first to fourth strain gauges respectively arranged on the first to fourth surfaces.

In accordance with the seventh aspect, it is possible to detect, by the first to fourth strain gauges, deformation of a part of the top plate which part is closer to the center of the top plate both in a vertical direction and a horizontal direction with respect to the surface of the top plate.

A force plate in accordance with an eighth aspect may be configured such that, in the sixth or seventh aspect, the top plate has a first side, a second side, . . . , and an n-th side, the first side being arranged at a location between the first corner and the second corner in a plan view, the second side being arranged a location between the second corner and the third corner in a plan view, . . . , and the n-th side being arranged at a location between the n-th corner and the first corner in a plan view; the strain element includes first to n-th center-side beam members that are arranged closer to the center of the top plate in such a manner that the first to n-th center-side beam members respectively correspond to the first to n-th sides; each of the first to n-th center-side beam members is connected with an adjacent center-side beam member at a corresponding one of first to n-th connection parts respectively corresponding to the first to n-th corners; and each of the first to n-th periphery-side beam members is connected with at least one of the first to n-th center-side beam members at a corresponding one of the first to n-th connection parts.

In accordance with the eighth aspect, it is possible to deal with deformation of the first to n-th sides of the top plate by the first to n-th center-side beam members.

A force plate in accordance with a ninth aspect may be configured such that, in the eighth aspect, each of the first to n-th center-side beam members has a fifth surface that faces the main surface of the top plate, a sixth surface that is located opposite to the main surface of the top plate, and a seventh surface and an eighth surface that intersect the main surface of the top plate; and the plurality of strain gauges include fifth to eighth strain gauges respectively arranged on the fifth to eighth surfaces.

In accordance with the ninth aspect, it is possible to detect, by the fifth to eighth strain gauges, deformation of a part of the top plate which part is closer to the periphery of the top plate both in the vertical direction and the horizontal direction with respect to the surface of the top plate. Furthermore, it is also possible to detect twisting of the part of the top plate which part is closer to the periphery.

A force plate in accordance with a tenth aspect may be configured such that, in any one of the first to ninth aspects, the force plate further includes: a detection section configured to detect at least one of an acceleration, an angular velocity, and an inclination of the top plate.

In accordance with the tenth aspect, it is possible to detect, in addition to the deformation of the top plate, at least one of an acceleration, an angular velocity, and an inclination of the entire top plate.

The present disclosure is not limited to the above-described embodiments, but can be altered by a skilled person in the art within the scope of the claims. The present disclosure also encompasses, in its technical scope of the present disclosure, any embodiment derived by combining technical means disclosed in differing embodiments.

1. A force plate comprising:
a base plate;
a top plate attached to the base plate;
a strain element attached to the top plate, the strain element being configured to be deformed in accordance with deformation of the top plate; and
a plurality of strain gauges configured to detect deformation of the strain element.

2. The force plate according to claim 1, further comprising:
a plurality of connection members that connect the base plate and the top plate with each other in such a manner as to allow the top plate to be deformed with respect to the base plate.

3. The force plate according to claim 2, wherein:
the plurality of connection members respectively include spherical bearings.

4. The force plate according to claim 3, wherein:
the plurality of connection members respectively include
(a) bar-shaped members each of which is connected with one of the base plate and the top plate and
(b) the spherical bearings each of which connects the other of the base plate and the top plate with a corresponding one of the bar-shaped members; and
each of the spherical bearings includes
(a) an outer ring that is connected with the other of the base plate and the top plate and
(b) an inner ring that is attached to a corresponding one of the bar-shaped members.

5. The force plate according to claim 2, wherein:
the top plate has a polygonal shape having first to n-th corners in a plan view, where n is an integer of not less than three; and
the plurality of connection members include first to n-th connection members that are respectively arranged at first to n-th connection positions, which are closer to the first to n-th corners than to a center of the top plate.

6. The force plate according to claim 5, wherein:
the strain element includes first to n-th periphery-side beam members that extend from the center of the top plate toward the first to n-th connection positions, respectively;
each of the first to n-th periphery-side beam members has
a first surface that faces a main surface of the top plate,
a second surface that is located opposite to the main surface of the top plate, and
a third surface and a fourth surface that intersect the main surface of the top plate; and
the plurality of strain gauges include first to fourth strain gauges respectively arranged on the first to fourth surfaces.

7. The force plate according to claim 6, wherein:
the top plate has a first side, a second side, . . . , and an n-th side, the first side being arranged at a location between the first corner and the second corner in a plan view, the second side being arranged a location between the second corner and the third corner in a plan view, . . . , and the n-th side being arranged at a location between the n-th corner and the first corner in a plan view;
the strain element includes first to n-th center-side beam members that are arranged closer to the center of the top plate in such a manner that the first to n-th center-side beam members respectively correspond to the first to n-th sides;
each of the first to n-th center-side beam members is connected with an adjacent center-side beam member at a corresponding one of first to n-th connection parts respectively corresponding to the first to n-th corners;
each of the first to n-th periphery-side beam members is connected with at least one of the first to n-th center-side beam members at a corresponding one of the first to n-th connection parts;
each of the first to n-th center-side beam members has
a fifth surface that faces the main surface of the top plate,
a sixth surface that is located opposite to the main surface of the top plate, and
a seventh surface and an eighth surface that intersect the main surface of the top plate; and
the plurality of strain gauges include fifth to eighth strain gauges respectively arranged on the fifth to eighth surfaces.

8. The force plate according to claim 1, further comprising:
a detection section configured to detect at least one of an acceleration, an angular velocity, and an inclination of the top plate.
